(19) United States
(12) Patent Application Publication
(10) Pub. No.: US 2013/0152034 A1
(43) Pub. Date: Jun. 13, 2013

(54) SYSTEM AND METHOD FOR REDUCING INTEGRATED CIRCUIT TIMING DERATING

(71) Applicant: Alexander Tetelbaum, Walnut Creek, CA (US)

(72) Inventor: Alexander Tetelbaum, Walnut Creek, CA (US)

(73) Assignee: LSI Corporation, Milpitas, CA (US)

(21) Appl. No.: 13/315,519

(22) Filed: Dec. 9, 2011

(51) Int. Cl. G06F 17/50

(52) U.S. Cl. 716/113

(57) ABSTRACT

A system for, and method of, reducing IC timing derating for a path in an integrated circuit design. In one embodiment, the system includes an electronic design automation tool configured to (1) extract circuit data regarding cells in the path and (2) calculate a timing derating for the path based at least in part on a determination as to whether the cells are simple cells.

### TECHNICAL FIELD

This application is directed, in general, to integrated circuit (IC) design and, more specifically, to a timing signoff system and method that takes static and dynamic voltage drop into account.

### BACKGROUND

Circuit designers use electronic design automation (EDA) tools, a category of computer aided design (CAD) tools, to design and lay out electronic circuits, including simulating the operation of the circuit, determining where cells (i.e., logic elements including devices, e.g., transistors) should be placed and where the interconnects that couple the cells together should be routed. EDA tools allow designers to construct a circuit and simulate its performance using a computer and without requiring the costly and lengthy process of fabrication. EDA tools are indispensable for designing modern ICs, particularly very-large-scale integrated circuits (VSLICs). For this reason, EDA tools are in wide use.

One such EDA tool performs timing signoff. Timing signoff is one of the last steps in the IC design process and ensures that signal propagation speed (i.e., delay) in a newly-designed circuit is such that the circuit will operate as intended. Signals that propagate too slowly through the circuit cause setup violations; signals that propagate too quickly through the circuit cause hold violations. Setup or hold violations frustrate the logic of the circuit and prevent it from performing the job it was designed to do.

Timing signoff is performed with highly accurate models of the circuit under multiple sets of assumptions regarding expected variations, called “corners.” Process-voltage-temperature (PVT) corners are based on assumptions regarding variations in device operation from one IC to another, supply voltage and operating temperature. Resistance-capacitance (R, C, or RC) corners are based on assumptions regarding variations in one or both of interconnect resistance and capacitance from one IC to another. Conventional timing signoff identifies setup and hold violations in a “slow” PVT corner (in which process variations are assumed to yield relatively slow-switching devices and supply voltage and operating temperature are such that device switching speed are their slowest) and a “worst” RC corner (in which process variations are assumed to yield interconnects having relatively high resistance and capacitance). Conventional timing signoff also identifies hold violations in a “fast” PVT corner (in which process variations are assumed to yield relatively fast-switching devices and supply voltage and operating temperature are such that device switching speeds are their fastest) and a “best” RC corner (in which process variations are assumed to yield interconnects having relatively low resistance and capacitance). Conventional signoff timing also takes on-chip variations (OCV), which are process variations occurring over the area of a given IC, into account using statistical methods. Timing derating factors may be employed during STA to model the effects of process variations. The derating factors, which are usually expressed in terms of a percentage, specify the degree to which all or specific gates, nets or both in a given IC design should be sped up or slowed down.

### SUMMARY

One aspect provides a system for reducing timing derating for a path in an IC design. In one embodiment, the system includes an electronic design automation tool configured to (1) extract circuit data regarding cells in the path and (2) calculate a timing derating for the path based at least in part on a determination as to whether the cells are simple cells.

Another embodiment provides a system including an electronic design automation tool configured to: (1) extract circuit data regarding cells in the path, (2) calculate a timing derating for the path, (3) employ a global assumed average internal logic depth for ones of the cells that are simple cells, (4) determine internal depth of hierarchical cells in the path from inputs to outputs of the hierarchical cells and (5) set internal depth of ones of the cells that are complex cells in the path to predetermined numbers.

Another aspect provides a method of reducing timing derating for a path in an IC design. In one embodiment, the method includes: (1) extracting circuit data regarding cells in the path from a database and (2) calculating a timing derating for the path based at least in part on a determination as to whether the cells are simple cells.

Yet another aspect provides a computer-readable storage medium containing program instructions for reducing timing derating for a path in an IC design, execution of the program instructions by one or more processors of a computer system causing the one or more processors to: (1) extract circuit data regarding cells in the path and (2) calculate a timing derating for the path based at least in part on a determination as to whether the cells are simple cells.

### BRIEF DESCRIPTION

Reference is now made to the following descriptions taken in conjunction with the accompanying drawings, in which:

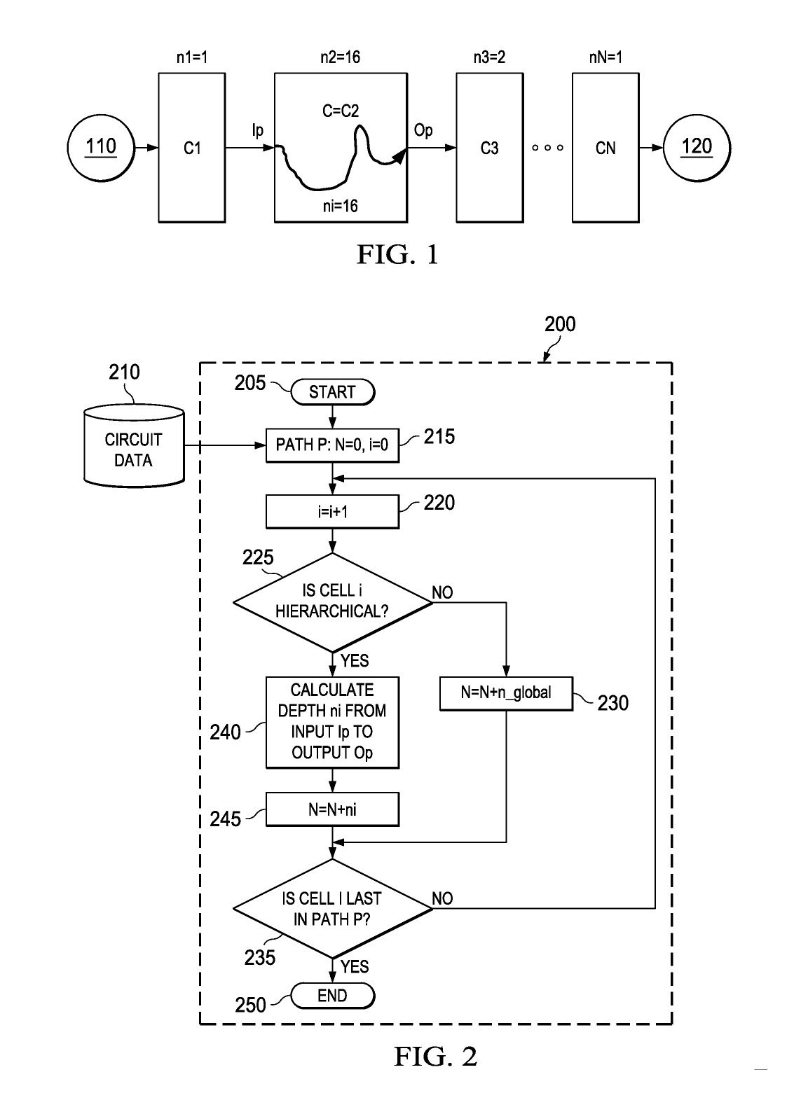

FIG. 1 is a highly schematic block diagram of an example path in an example IC design having a hierarchical cell;

FIG. 2 is a hybrid block and flow diagram of one embodiment of a system and method for reducing IC timing derating for a path containing a hierarchical cell;

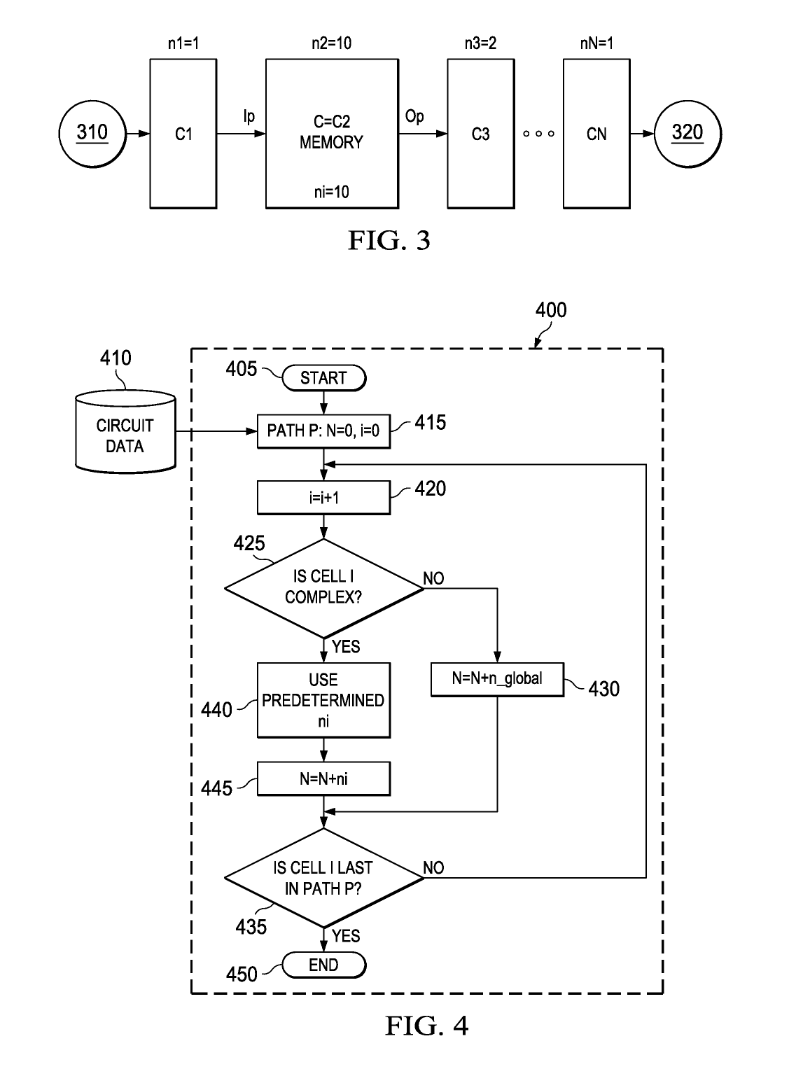

FIG. 3 is a highly schematic block diagram of an example path in an example IC design having a complex cell; and

FIG. 4 is a hybrid block and flow diagram of one embodiment of a system and method for reducing IC timing derating for a path containing a complex cell.

### DETAILED DESCRIPTION

Described herein are various embodiments of a system and method for reducing the total timing derating that is to be applied to logical or clock paths of hierarchical designs or designs with complex cells during timing signoff to take OCV into account. Some embodiments of the system and method allow the total timing derating to be reduced to a minimum. Other embodiments reduce the timing derating that is to be applied to both logical and clock paths.

A relatively sophisticated but conventional process for determining timing derating and performing STA timing signoff is “Advanced OCV,” or AOCV, commercially available as part of the PrimeTime® system from Synopsys of Mountain View, Calif. AOCV assigns cell and net deratings as a function of a (logical) path depth N and a (physical) distance D of cells. Unfortunately, AOCV only analyzes paths down to the cell level. It does not take into account the internal logic depth (ni) of the cells themselves. Instead, AOCV globally (for all cells in an IC design) assumes an average internal logic depth. Thus, AOCV is unable to distinguish simple cells (those having a relatively shallow logic depth) from hierarchical cells (those having cells in multiple hierarchical levels) or complex cells (those having a significant logic depth of perhaps dozens of levels in a single hierarchical level, such as memory). Cells having multiple hierarchical levels and a significant logic depth in any one or more of those levels can be both hierarchical and complex. Because AOCV cannot distinguish simple cells from either hierarchical or complex cells, it tends to assign excessive deratings to the hierarchical or complex cells. The assigned excessive deratings result in excessive overall path deratings and an overall performance penalty for the IC design as a whole.

This deficiency may be better understood with reference to an example path having N cells, C1, C2, . . . , CN. Most of the cells C1, C3, . . . , CN are simple cells. However, one of the cells, C2, is a complex cell having 16 internal logic levels. Since the overall depth of a path is dependent upon the depth of the cells in the path, an excessive path derating results if the global assumed average internal logic depth is set incorrectly. For example, were the global assumed average internal logic depth to be set at a value appropriate for a path Containing only simple cells (about 1.5), an excessive derating would result for the example path. On the other hand, were the global assumed average internal logic depth increased to a level that yields a correct derating for the example path, other paths containing only simple cells would be assigned an incorrect derating.

Accordingly, the system and method for reducing the total timing derating introduced herein are capable of calculating, for one or more hierarchical cells in a given IC design, the appropriate internal logic depth from the inputs to the outputs of each hierarchical cell.

Related embodiments of the system and method further allow a user to specify an internal depth or a timing derating for one or more complex cells in a given IC design. More specific embodiments of the system and method allow the user to specify an internal depth or timing derating for every complex cell in the given IC design or for all instances of a given cell employed in multiple IC designs.

Other embodiments of the system and method described herein introduce a timing signoff process for an IC design in which the appropriate hierarchical levels and internal depth of hierarchical or complex cells in the design are taken into account in calculating the path derating for the design.

Certain illustrated embodiments of the system and method are configured to employ a threshold for internal logic depth to discriminate between simple cells, hierarchical cells and complex cells. Then, the illustrated embodiments are configured to employ global average internal logic depth as a basis for determining the timing derating for the simple cells and one or more other bases for determining the internal logic levels if the hierarchical cells and complex cells.

An improvement of AOCV exists that employs multiple assumed average numbers of internal logic levels in lieu of a single, global assumed average number. However, this improvement neither analyzes hierarchical cells to calculate their appropriate internal depth or allows a user to specify the internal depth of complex cells.

FIG. 1 is a highly schematic block diagram of an example path in an example IC design having a hierarchical cell. The path begins at a point 110 and proceeds through N cells, C1, C2, . . . , CN. The cells C1, C3, . . . , CN are simple cells (having fewer than a threshold internal logic depth), viz., n1=1, n3=2, nN=1. However, one of the cells, C2, is a hierarchical cell having 16 internal logic levels, viz., n2=16. The path ends at a point 120.

FIG. 2 is a hybrid block and flow diagram of one embodiment of a system and method for reducing IC timing derating for a path containing a hierarchical cell, including the path of FIG. 1. The system includes an EDA tool 200. In the illustrated embodiment, the EDA tool 200 includes or is an enhanced embodiment of a conventional STA tool such as the aforementioned PrimeTime®. To perform timing signoff with respect to an IC design, the illustrated embodiment of the EDA tool 200 is configured to extract data regarding the design from a database 210 configured to contain circuit data.

To reiterate the most advanced conventional timing derating process described above, AOCV calculates the depth N of a path P simply by counting the number of cells in the path and then calculating a final N for the path P as Tp=F(N*n_global, where n_global is a global assumed average internal logic depth. However, the global assumed average does not reflect significant variations in cell logic depth and is therefore inappropriate for the path of FIG. 1, which contains the hierarchical cell C2 (ni=n2=16). The correct number of logic levels in path P should be (N−1)*n_global+n2, but the conventional timing derating process does not yield this result.

Having described the conventional timing derating process, the method of FIG. 2 will now be described. The method begins in a start step 205. A path to be derated is selected in a step 215, and circuit data regarding the cells in the selected path are retrieved from the database 210. N (path timing derating) and i (path cell number) are initialized to 0, and a threshold internal logic depth is set, e.g., to three (signifying that a cell having fewer than three internal logic levels is to be regarded as a simple cell). In a step 220, i is incremented. In a decisional step 225, with reference to the set threshold internal logic depth of three, it is determined whether or not i is a hierarchical cell. If NO, a new N is set equal to its previous value plus n_global. Then, in a decisional step 235, it is determined whether or not the cell i is the last cell in the path P. If NO, the method returns to the step 220 in which i is again incremented and the decisional step 225 repeated for the next cell in the path P. If YES, the method ends in an end step 250.

If the outcome of the decisional step 225 is YES, the depth ni of the cell i is calculated from its input Ip to its output Op in a step 240. In the step 240, the hierarchical cell is internally examined to determine the depth ni of its internal path from its input Ip to its output Op. The internal path of the hierarchical cell may itself include one or more hierarchical cells, one or more complex cells, or both. If so, the method of FIG. 2 is recursively carried out with respect to the internal hierarchical cells, and the method of FIG. 4 is applied to the internal complex cells, at each level of recursion. (The method of FIG. 4 will be described below, but calls for the ni of any complex cells to be set to a predetermined number, perhaps provided by the designer of the cell, appropriate for the complex cell.) In the illustrated embodiment, no limit exists as to the number of levels of recursion that may exist in a given IC design and be analyzed by the timing derating reducing methods of FIGS. 2 and 4.

When any and all levels of recursion in the hierarchical cell have been taken into account in calculating ni for the hierarchical cell, N is set equal to its previous value plus ni in a step 245. The decisional step 235 is then invoked to determine whether or not the cell i is the last cell in the path P. If NO, the method returns to the step 220 in which i is again incremented and the decisional step 225 repeated for the next cell in the path P. If YES, the method ends in the end step 250.

FIG. 3 is a highly schematic block diagram of an example path in an example IC design having a complex cell. The path begins at a point 310 and proceeds through N cells, C1, C2, . . . , CN. The cells C1, C3, . . . , CN are simple cells (having one or two internal logic levels), viz., n1=1, n3=2, nN=1. However, one of the cells, C2, is a complex cell having 10 internal logic levels, viz., n2=10. In the illustrated embodiment, the complex cell C2 is a memory cell, which those skilled in the pertinent art recognize to have a relatively large depth and which should not be deemed simple. The path ends at a point 320.

FIG. 4 is a hybrid block and flow diagram of one embodiment of a system and method for reducing IC timing derating for a path containing a complex cell. The system includes an EDA tool 400. In the illustrated embodiment, the EDA tool 400 includes or is an enhanced embodiment of a conventional STA tool such as the aforementioned PrimeTime®. To perform timing signoff with respect to an IC design, the illustrated embodiment of the EDA tool 400 is configured to extract data regarding the design from a database 410 configured to contain circuit data.

The method begins in a start step 405. A path to be derated is selected in a step 415, and circuit data regarding the cells in the selected path are retrieved from the database 410. N and i are initialized to 0, and a threshold internal logic depth is set, e.g., to four (signifying that a cell having fewer than four internal logic levels is to be regarded as a simple cell). In a step 420, i is incremented. In a decisional step 425, with reference to the set threshold internal logic depth of four, it is determined whether or not i is a complex cell. If no, a new N is set equal to its previous value plus n_global. Then, in a decisional step 435, it is determined whether or not the cell i is the last cell in the path P. If NO, the method returns to the step 420 in which i is again incremented and the decisional step 425 repeated for the next cell in the path P. If YES, the method ends in an end step 450.

If the outcome of the decisional step 425 is NO, ni is set to a predetermined number appropriate for the complex cell. In the illustrated embodiment, ni is provided by the designer of the complex cell. In an alternative embodiment, ni may be derived from a simulated operation of the cell. In one embodiment, ni may be retrieved from the database 410.

In a step 445, N is set equal to its previous value plus ni. The decisional step 435 is then invoked to determine whether or not the cell i is the last cell in the path P. If NO, the method returns to the step 420 in which i is again incremented and the decisional step 425 repeated for the next cell in the path P. If YES, the method ends in the end step 450.

Those skilled in the art to which this application relates will appreciate that other and further additions, deletions, substitutions and modifications may be made to the described embodiments.

1. A system for reducing timing derating for a path in an integrated circuit design, the system comprising:
an electronic design automation tool configured to:
extract circuit data regarding cells in said path;
for one or more cells in said path, determine whether said cell is a simple cell;
if said cell is a simple cell, calculate a timing derating for said path using a predetermined internal logic depth; and
if said cell is not a simple cell, calculate a timing derating for said path using a dynamically calculated internal logic depth for said cell.

2. The system as recited in claim 1, wherein said electronic design automation tool is configured to employ a global assumed average internal logic depth for ones of said cells that are said simple cells.

3. The system as recited in claim 1, wherein said electronic design automation tool is configured to determine internal depth of hierarchical cells in said path from inputs to outputs of said hierarchical cells, said internal depth including any levels of recursion said hierarchical cells have.

4. The system as recited in claim 1, wherein said electronic design automation tool is configured to set internal depth of ones of said cells that are complex cells in said path to predetermined numbers.

5. The system as recited in claim 4, wherein at least one of said predetermined numbers is provided by a designer of a corresponding one of said complex cells.

6. The system as recited in claim 1, wherein said electronic design automation tool is configured to extract circuit data for cells in other paths in said integrated circuit design and calculate timing deratings for all paths in said integrated circuit design.

7. (canceled)

8. A method of reducing timing derating for a path in an integrated circuit design, comprising:
extracting circuit data regarding cells in said path from a database;
for one or more cells in said path, determine whether said cell is a simple cell;
if said cell is a simple cell, calculate a timing derating for said path using a predetermined internal logic depth; and
if said cell is not a simple cell, calculating a timing derating for said path using a dynamically calculated internal logic depth for said cell.

9. The system as recited in claim 8, wherein said calculating comprises employing a global assumed average internal logic depth for ones of said cells that are said simple cells.

10. The system as recited in claim 8, wherein said calculating comprises determining internal depth of hierarchical cells in said path from inputs to outputs of said hierarchical cells, said internal depth including any levels of recursion said hierarchical cells have.

11. The system as recited in claim 8, wherein said calculating comprises setting internal depth of ones of said cells that are complex cells in said path to predetermined numbers.

12. The system as recited in claim 11, wherein at least one of said predetermined numbers is provided by a designer of a corresponding one of said complex cells.

13. The system as recited in claim 8, wherein said calculating comprises:
extracting circuit data for cells in other paths in said integrated circuit design; and
calculating timing deratings for all paths in said integrated circuit design timing deratings for all paths in said integrated circuit design.

14. A system for reducing timing derating for a path in an integrated circuit design, comprising:
an electronic design automation tool configured to:
extract circuit data regarding cells in said path;
calculate a timing derating for said path;
for one or more cells in said path, determine whether said cell is a simple cell;
if said cell is a simple cell, employ a global assumed average internal logic depth;
if said cell is a hierarchical cell, determine an internal logic depth of said hierarchical cell, said internal depth including any levels of recursion of said hierarchical cell cells have; and
if said cell is a complex cell, set an internal logic depth of said complex cell to a predetermined number.

15. The system as recited in claim 14, wherein said predetermined number is provided by designers of said complex cells.

16. The system as recited in claim 14, wherein said electronic design automation tool is configured to extract said circuit data and calculate timing deratings for all paths in said integrated circuit design.

17. The system as recited in claim 14, wherein said electronic design automation tool is a static timing analysis tool.

18. A computer-readable storage medium containing program instructions for reducing timing derating for a path in an integrated circuit design, execution of said program instructions by one or more processors of a computer system causing said one or more processors to:
extract circuit data regarding cells in said path;
for one or more cells in said path, determine whether said cell is a simple cell;
if said cell is a simple cell, calculate a timing derating for said path using a predetermined internal logic depth; and
if said cell is not a simple cell, calculate a timing derating for said path using a dynamically calculated internal logic depth for said cell.

19. The computer-readable medium as recited in claim 18, wherein said execution of said program instructions by said one or more processors causes said one or more processors to employ a global assumed average internal logic depth for ones of said cells that are said simple cells.

20. The computer-readable medium as recited in claim 18, wherein said execution of said program instructions by said one or more processors causes said one or more processors to determine internal depth of hierarchical cells in said path from inputs to outputs of said hierarchical cells, said internal depth including any levels of recursion said hierarchical cells have.

21. The computer-readable medium as recited in claim 18, wherein said execution of said program instructions by said one or more processors causes said one or more processors to set internal depth of complex cells in said path to predetermined numbers.

22. The system as recited in claim 1, wherein:
said cell which is not a simple cell is a hierarchical cell comprising one or more further cells; and
dynamically calculating an internal logic depth for said hierarchical cell comprises dynamically calculating an internal logic depth for at least one of said one or more further cells.
